(19) United States
(12) Patent Application Publication
(10) Pub. No.: US 2022/0001625 A1
(43) Pub. Date: Jan. 6, 2022

(54) Generation of Control Data for Three-Dimensional Printers

(71) Applicant: Hewlett-Packard Development Company, L.P., Spring, TX (US)

(72) Inventors: Leticia RUBIO CASTILLO, Sant Cugat del Vallès (ES); Sergio GONZALEZ MARTIN, Sant Cugat del Vallès (ES); Alex CARRUESCO LLORENS, Sant Cugat del Vallès (ES); Salvador SANCHEZ RIBES, Sant Cugat del Vallès (ES)

(21) Appl. No.: 17/294,935

(22) PCT Filed: Apr. 29, 2019
(86) PCT No.: PCT/US2019/029594

§ 371 Date: May 18, 2021

(51) Int. Cl. B29C 64/393; B29C 64/209; B29C 64/236; B29C 64/268

(52) U.S. Cl. CPC B29C 64/393; B29C 64/209; B33Y 50/02; B29C 64/268; B29C 64/236

(57) ABSTRACT

Object model data is obtained, defining an object to be generated by a three-dimensional printer. An envelope is obtained within which the object is to be generated, the envelope having a main section and at least one of a base and/or a lid, and printer control data is generated comprising build data to control a three-dimensional printer to generate the object and the envelope and a build mode data, wherein the printer control data comprises instructions to cause a three-dimensional printer to generate a build layer of the base and/or lid of the envelope using a first build mode, and to generate the object using a second build mode. The first build mode uses an extended time-per-build-layer for the generating of the build layer of the base and/or lid of the envelope compared with the second build mode.

### BACKGROUND

Following completion of a build operation in a powder-based three-dimensional (3D) printer, build objects may be cooled before they are removed from the build chamber to avoid damaging the build objects while in a structurally vulnerable state. A build object may be generated within an envelope, during a build operation.

### BRIEF DESCRIPTION OF THE DRAWINGS

FIG. 1 is an example of a 3D build comprising a printed object contained within a printed envelope.

FIG. 2 is an example of a method for generating printer control data.

FIG. 3 is an example of a controller configured to generate printer control data.

FIG. 4 is an example of a computer readable medium comprising instructions to generate printer control data.

### DETAILED DESCRIPTION

In a powder-based 3D printer, an object may be generated by selectively fusing powder in a build chamber connected to a printing unit which controls the build operation. After the completion of the build operation, the build chamber containing the object may be disconnected from the printing unit. In systems using thermal fusing of build material, the object may be cooled before removal from the build chamber. Once the powder of the build chamber is cold enough to extract the object, the build chamber may be emptied and connected back to the printing unit to start a new printing process. The cooling of an object in the build chamber may take a considerable amount of time which may prevent the build chamber from being used for other purposes during this time.

To extract a warm build out of the build chamber just after the end of the printing process, for external cooling, an envelope may be printed around the build object during the printing of the build object, to ensure that the print quality of the non-cooled build parts is not affected during the early extraction when the build is in a structurally vulnerable state. The envelope may have a main section and at least one of a base and/or a lid. The base and/or lid of the envelope may be a cover(s) covering the main section of the envelope. The printing of the base and/or lid of the envelope may involve intense usage of the printer's powder solidification system due to the large continuous area of solidified powder.

In some applications, such as non-thermal fusion systems, an envelope(s) may be generated around selected print objects to keep them together, e.g. to group print objects intended for the same customer.

The present disclosure describes how generation of printer control data may be improved to reduce the stress on powder-based 3D printing systems during the printing of the base and/or lid of the envelope.

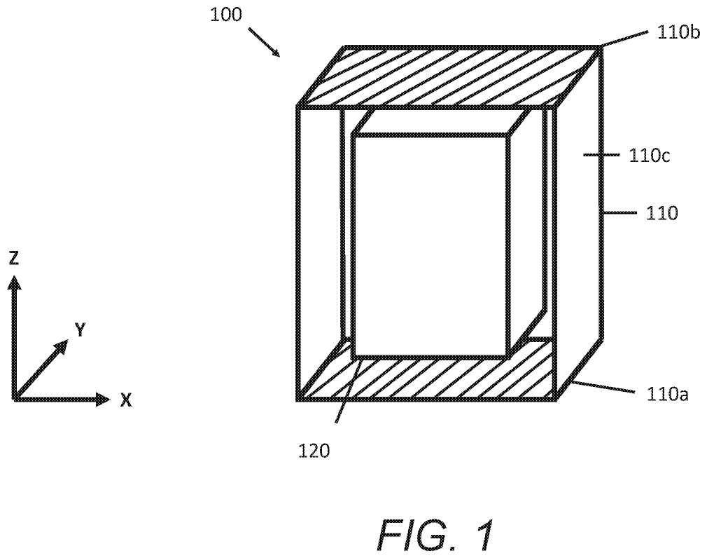

FIG. 1 shows an example of a 3D build 100 comprising an object 120 contained within an envelope 110. The envelope 110 has a base 110a and a lid 110b. In some examples, the envelope 110 may comprise one of: a base 110a or lid 110b. The envelope 110 may have any geometry so long as it is large enough to contain the object 120. In some examples, the envelope 110 may not fully contain the object 120 but may have a geometry suitable for facilitating removal of the object 120 from a build chamber without the need for physical contact with the object 120.

In an example of the disclosure, the build process may include the generating of a first layer of the base 110a of the envelope 110. A layer of build powder is applied to a powder bed of a build platform. Once the build powder has been applied, a printer carriage comprising at least one bonding element may be passed across the powder bed to cause the selective binding/solidification of the build powder at predefined locations. In some powder-bed printing technologies, the bonding element may be a print nozzle, or a printhead having print nozzles for depositing a print agent, such as a chemical binder agent in a binder jetting system, or a fusing agent in a thermal fusing system, onto the build powder. In other powder-bed printing technologies, such as selective laser sintering (SLS) systems, the bonding element may be a laser, a movable mirror for directing/focusing a laser, or an array of lasers which are situated on the printer carriage. The laser or plurality of lasers may apply bonding energy to predefined locations of the build powder as the printer carriage passes across the powder bed. After each layer of the build is complete, the build platform may be displaced a predetermined distance along the Z axis and a new layer of build powder may be applied to the previous layer to facilitate the printing of the next layer of the 3D build 100. In some examples, the predetermined distance may be based on the level of detail in the layer to be printed. In other examples, the predetermined distance may be based on desired material properties of the layer to be printed. Once all layers of the base 110a are printed, the layers for the object 120 may be printed along with side walls 110c of the envelope 110.

Once all layers of the object 120 and side walls of the envelope 110 are complete, a first layer of the lid 110b of the envelope 110 may be printed. In some 3D printing operations, separation layers may be included between the object 120 and the base 110a and/or between the object 120 and the lid 110b of the envelope 110. In thermal fusion printing systems, the inclusion of the separation layers prevents the printing of the envelope 110 from affecting the thermal behaviour and the part quality of the printed object 120. The number of separation layers may be defined by analysing the thermal behaviour of the build material.

The base 110a and lid 110b of the envelope 110 can be, as an example, a sequence of layers with wide fused areas. Such large surface build layers may cause the printheads in thermal fusion systems or binder jetting systems to fire at their maximum duty cycle, increasing wear on the print nozzles and/or printheads.

In other systems such as SLS systems, generating large surface build layers may lead to high temperatures at certain points on the powder bed, increasing the possibility of surrounding parts of the build being affected by thermal bleed. Thermal bleed may also result from the generation of large surface build layers in a thermal fusing printing system.

In an example of the disclosure, the stress on powder-bed printing systems when building the base 110a and/or lid 110b of the envelope 110 may be reduced by generating printer control data comprising instructions to cause a 3D printer to construct elements of the build in a different manner or using a different build mode compared with the build mode used for other elements of the build. In one example, the build data comprising a build object model and an envelope model is sliced into a plurality of slices corresponding to respective layers of build material facilitating the allocation or assignment of a first build mode (or print mode) to a particular layer or plurality of layers making up the base 110a and/or lid 110b of the envelope 110, and the allocation or assignment of a second build mode (or print mode) to the layers making up the object 120. In one example, the build data may comprise a spatial arrangement of object models. In such examples, the first build mode may reduce the intensity of the build process, e.g. the ratio of the printed volume to the print duration for a particular layer, by changing a sequence in which parts of the layer are generated, while maintaining uniform printing conditions during the building of the object. In one example, the generating of the printer control data includes instructions to generate the main section of the envelope using a build mode other than the second build mode. Since build quality requirements for the envelope 110 are lower than that for the build object 120, a faster/less precise build mode may be used for generating the side walls 110c of the envelope 110.

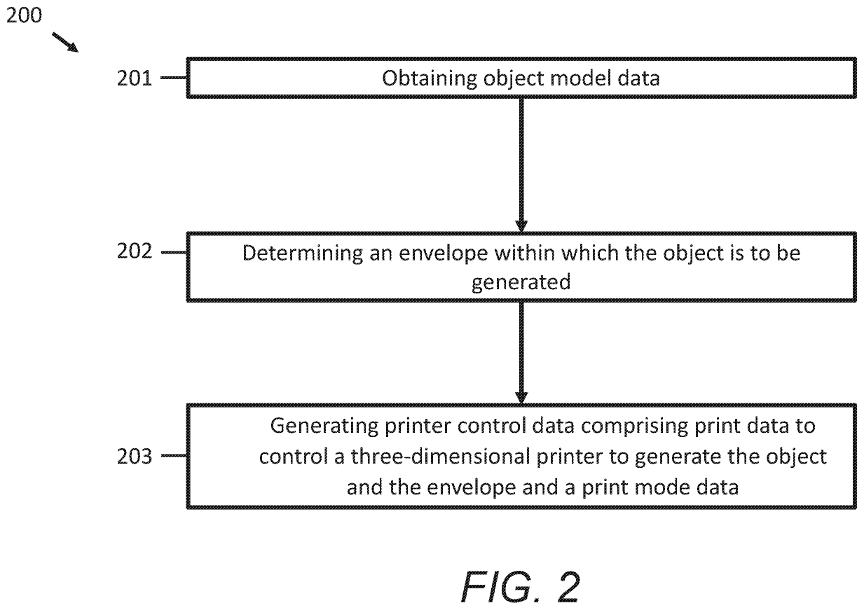

FIG. 2 shows an example of a method 200 for generating printer control data comprising build data to control a 3D printer to generate a build object 120 contained within an envelope 110. The method comprises obtaining 201 object model data defining an object 120 to be generated by a three-dimensional printer; determining 202 an envelope 110 within which the object 120 is to be generated, the envelope 110 having a main section and at least one of a base 110a and/or a lid 110b. In some examples, the base 110a and/or lid 110b of the obtained envelope 110 are in a plane parallel to the plane of the build platform. In some examples, the envelope 110 within which the object 120 is to be generated may be determined at 202 after the obtaining of object model data has been carried out. In some examples, the model data for the object and the envelope is obtained at the same time. At 203, the model data and the determined envelope are used to generate printer control data comprising build data to control a three-dimensional printer to generate the object 120 and the envelope 110 and a build mode data. The generated printer control data comprises instructions to use different build modes depending on which layer of the build is being printed. The use of a different build mode does not affect the content of the layer to be generated, but rather affects the steps or sequence in which a 3D printer carries out the generation of the layer. The content of each layer is determined by the model data for the object and the envelope. This facilitates the tailoring of the manner in which the generation of a particular layer takes place to alter the intensity of the build so as to reduce the stress on the 3D printing system or thermal stresses on parts of the build surrounding the layer being generated.

In one example, the generating 203 of printer control data may involve slicing the object model data and the envelope model into a plurality of slices corresponding to respective layers of build material, each to be allocated or assigned instructions to use a particular build mode (or print mode) during the printing of those layers. In another example, the model data for the object and envelope may be obtained in a sliced state having a plurality of layers, in which case the generating 203 of printer control data may involve assigning to each of the plurality of layers, instructions to use a particular build mode during the printing of those layers.

In examples in which the envelope model is determined based on an obtained object model, the slicing may be performed on a complete model including both the object 120 and the envelope 110. Alternatively, the obtained object model data may have already been sliced into a plurality of slices, in which case, the envelope may be determined or obtained in a sliced form and applied to the object model data to form a complete sliced build model including both the envelope 110 and the object 120. In this case, the appropriate build mode for each layer may be determined based on the position of the layer within the build model, in order to assign an appropriate build mode to layers corresponding to the object 120 and a base 110a and/or lid 110b of the envelope 110, respectively.

In an example, the printer control data comprises instructions to cause a three-dimensional printer to generate a build layer of the base 110a and/or lid 110b of the envelope 110 using a first build mode, and to generate the object 120 using a second build mode, wherein the first build mode uses an extended time-per-build-layer for the printing of the build layer of the base 110a and/or lid 110b of the envelope 110 compared with the second build mode. Extending the time in which a given layer is printed reduces the overall intensity of the printing of the given layer. In one example, the printer control data includes instructions to use a greater number of passes of a passing build carriage per build layer for build layers using the first build mode compared with the second build mode. The term “print pass” in this disclosure refers to where the printer carriage travels across the whole length of the powder bed. This may involve splitting the printing of the layer into multiple stages. For a binder jetting system, this may involve applying a thin layer of print agent to the build powder in a first pass of the printer carriage across the entire powder bed. A further thin layer of fusing agent may then be applied to the build powder in a second pass of the printer carriage to complete the build layer. For an SLS system, this may involve a first pass of the printer carriage, or a first laser scan, to pre-heat or prime the build powder, ready for subsequent pass(es) or scan(s) to complete the bonding of the build powder in the build layer.

In one example, the total content of the build layer to be generated may be divided into a plurality of images and instructions generated so that each of the plurality of images are printed during separate passes of the printer carriage over the build layer. Each of the plurality of images may designate the location of build sections to be printed and void/blank sections not to be printed on each respective pass of the printer carriage, during printing of a given build layer. In one example, the generated instructions may instruct a 3D printing system to print the build sections of one of the plurality of images during each pass of the printer carriage. In one example, the content of the build layer of the base 110a and/or lid 110b of the envelope 110 may be divided into two images. In this case, each of the two images may have void sections corresponding to build sections in the other image. In an example, the content of the build layer may be divided into two images, corresponding respectively to a checkerboard pattern and a corresponding inverse pattern. In one example, the division of the contents of the build layer may be random. In one example, the printer control data may comprise an instruction to use at least one different bonding element on the printer carriage in the separate passes. In another example, the printer control data may comprise an instruction to randomize the usage of bonding elements on the printer carriage in the separate passes.

Some examples may include predetermined time intervals either between print passes or at various stages of a print pass for a particular build layer.

In other examples, the number of complete passes of the printer carriage per build layer for the layers may not change between the first and second build modes. In one example, the content of the layer to be printed may be divided into a plurality of sections and instructions generated to wait a predetermined time interval between the generating of successive ones of the plurality of sections during generation of the build layer. In one example, the printer control data comprises instructions for a printer carriage having at least one bonding element to return to a predetermined position during the predetermined time interval.

In some examples, the printer control data may comprise an instruction to alter the velocity of the passing printer carriage when printing a layer using the first build mode. In one example, the velocity of the passing carriage is reduced in the first build mode. Reducing the velocity of the printer carriage will increase the time-per-build-layer for the generation of the layer, in order to reduce the intensity of the build process, e.g., the ratio of the printed volume to the print duration, and the corresponding stress on components such as print nozzles. This can facilitate, for example in binder jetting systems or thermal fusion systems, a lower rate of ejection of binding agent or fusing agent from the printheads, or in SLS systems, a lower laser energy level for the bonding of a build layer.

In some examples, the printer control data may comprise an instruction to increase the velocity of the printer carriage when generating a build layer using the first build mode. This increase in printer carriage velocity can provide a degree of compensation for build modes having an extended time-per-build-layer, such as the examples described above. This compensation can also be achieved by an example where the generating of the printer control data includes instructions to generate the build layer of the base and/or lid of the envelope during a warm-up and/or cool-down phase of a build sequence, such as during an annealing stage of the build sequence.

In an example of the disclosure, the generating of printer control data comprises build data to control a three-dimensional powder-based printer comprising a build carriage having at least one printing nozzle to inject a print agent to generate the object and the envelope and build mode data.

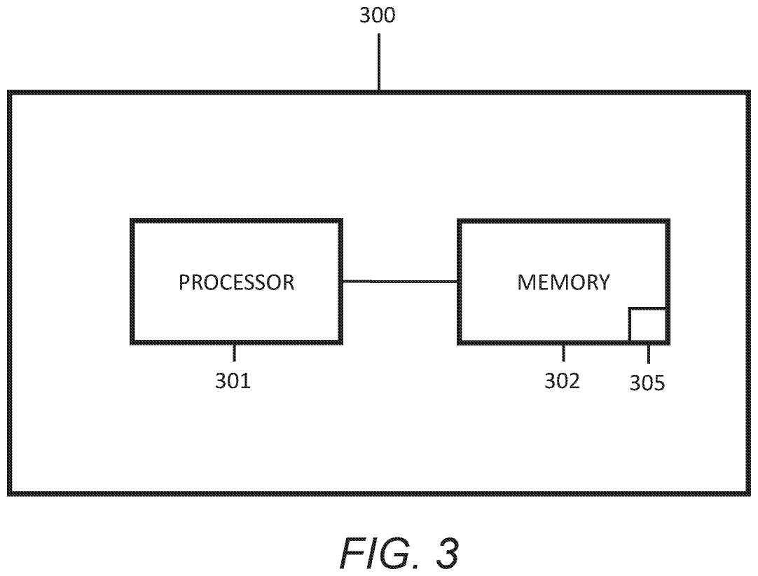

FIG. 3 shows an example of controller 300 configured to generate printer control data. The controller 300 comprises a processor 301 and a memory 302. Stored within the memory 302 are instructions 305 for generating printer control data according to any one of the example methods disclosed above. In an example, controller 300 may be part of a computer running the instructions 305. In another example, controller 300 may be part of a powder-based 3D printer configured to run the instructions 305 after obtaining object model data.

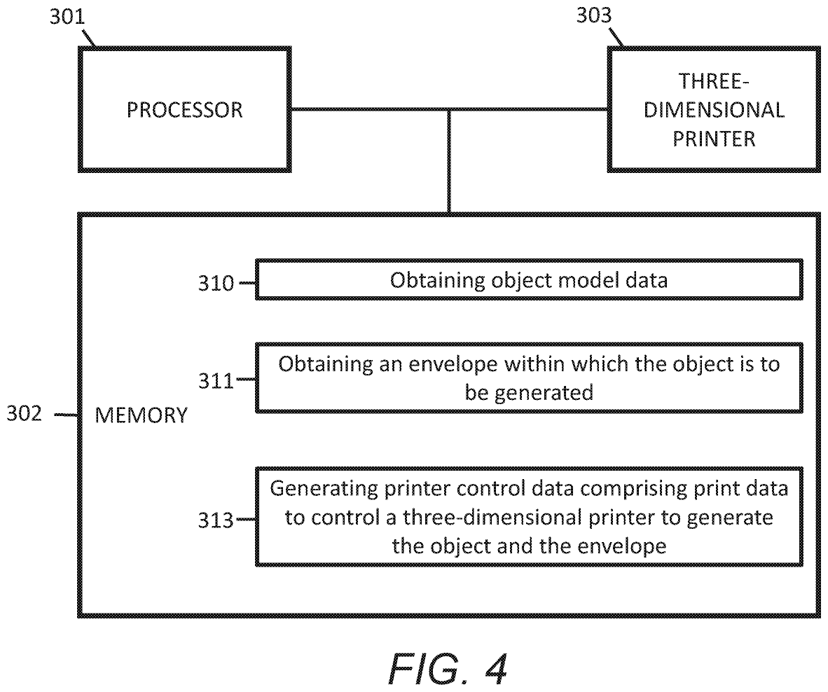

FIG. 4 shows a memory 302 which is an example of a computer-readable medium storing instructions that, when executed by a processor 301 communicably coupled to an additive manufacturing system 303, causes the processor 301 to generate printer control data. The computer-readable medium may be any electronic magnetic, optical or other physical storage device that stores executable instructions. Thus, the non-transient computer readable medium may be, for example, Random Access Memory (RAM), and Electrically-erasable Programmable read-Only Memory (EEPROM), a storage drive, an optical disc, and the like.

1. A method comprising:
obtaining object model data defining an object to be generated by a three-dimensional printer;
determining an envelope within which the object is to be generated, the envelope having a main section and at least one of a base and/or a lid; and
generating printer control data comprising build data to control a three-dimensional printer to generate the object and the envelope and a build mode data, wherein the printer control data comprises instructions to cause a three-dimensional printer to generate a build layer of the base and/or lid of the envelope using a first build mode, and to generate the object using a second build mode, wherein the first build mode uses an extended time-per-build-layer for the generating of the build layer of the base and/or lid of the envelope compared with the second build mode.

2. The method of claim 1, wherein the printer control data includes an instruction to use a greater number of passes of a passing printer carriage per build layer, by dividing the solidification of build material in a given build layer between respective passes, for build layers using the first build mode compared with the second build mode.

3. The method of claim 1, wherein generating the printer control data comprises dividing the content of the build layer of the base and/or lid of the envelope into a plurality of images, and allocating each of the plurality of images for generation in the build layer during separate passes of a printer carriage over the build layer.

4. The method of claim 3, wherein the content of the build layer of the base and/or lid of the envelope is divided into two images, each of the two images having void sections corresponding to build sections in the other image.

5. The method of claim 3, wherein the printer control data comprises an instruction to use at least one different bonding element on the printer carriage in the separate passes.

6. The method of claim 5, wherein the bonding element on the printer carriage comprises any one of: a print head; a movable mirror or a laser array.

7. The method of claim 1, wherein generating the printer control data comprises dividing the content of the build layer of the base and/or lid of the envelope into a plurality of sections, wherein for a build layer using the first build mode, the printer control data includes instructions to wait a predetermined time interval between the generation of successive ones of the plurality of sections during generation of the build layer.

8. The method of claim 7, wherein the printer control data comprises instructions for a printer carriage comprising at least one bonding element to return to a predetermined position during the predetermined time interval.

9. The method of claim 2, wherein the printer control data comprises instructions to increase the velocity of the printer carriage when generating a build layer using the first build mode compared with the second build mode.

10. The method of claim 1, wherein the generating of the printer control data includes instructions to generate the main section of the envelope using a build mode other than the second build mode.

11. The method of claim 1, wherein the generating of the printer control data includes instructions to generate the build layer of the base and/or lid of the envelope during a warm-up and/or cool-down phase of a build sequence.

12. The method of claim 3, wherein the printer control data comprises an instruction to randomize the usage of bonding elements on the printer carriage in the separate passes.

13. The method of claim 1, wherein the generating of printer control data comprises build data to control a three-dimensional powder-based printer comprising a build carriage having at least one printing nozzle to inject a print agent to generate the object and the envelope and a build mode data.

14. A system comprising:
a controller configured to:
obtain object model data defining an object to be generated by an additive manufacturing system;
obtain envelope model data defining an envelope within which the object is to be generated, the envelope having a main section and at least one of a base and/or a lid; and
generate printer control data comprising build data to control an additive manufacturing system to generate the object and the envelope and a build mode data, wherein the build data comprises the object model data and the envelope model data, wherein the model data is sliced into a plurality of slices corresponding to respective layers of build material, wherein the build mode data comprises a plurality of build modes, wherein each of the plurality of layers is assigned one of the plurality of build modes, wherein the printer control data comprises instructions to cause the additive manufacturing system to generate a layer of the base and/or lid of the envelope using a first build mode, and to generate the object using a second build mode, wherein the first build mode uses an extended time-per-layer for the generating of the layer of the base and/or lid of the envelope compared with the second build mode.

15. A computer-readable medium comprising instructions that, when executed by a processor communicably coupled to an additive manufacturing system, causes the processor to:
obtain object model data defining an object to be generated by a three-dimensional printer;
obtain an envelope model defining an envelope within which the object is to be generated, the envelope having a main section and at least one of a base and/or a lid; and
generate printer control data comprising model data to control a three-dimensional printer to generate the object and the envelope and a build mode data, wherein the model data is based on the object model data and the envelope model, wherein the model data comprises a plurality of slices corresponding to respective print layers, wherein the build mode data comprises a plurality of print modes, wherein each of the plurality of print layers is assigned one of the plurality of print modes, wherein the printer control data comprises instructions to cause a three-dimensional printer to generate a print layer of the base and/or lid of the envelope using a first print mode, and to generate the object using a second print mode, wherein the first print mode uses an extended time-per-print-layer for the generating of the print layer of the base and/or lid of the envelope compared with the second print mode.
